(19) United States
(12) Patent Application Publication
(10) Pub. No.: US 2005/0071166 A1
(43) Pub. Date: Mar. 31, 2005

(54) Apparatus for the collection of data for performing automatic speech recognition

(75) Inventors: Liam D. Comerford, Carmel, NY (US); Jonathan H. Connell, Cortlandt Manor, NY (US); Chalapathy V. Neti, Yorktown Heights, NY (US); Thomas Picunko, Scarsdale, NY (US)

Correspondence Address: Philmore H. Colburn II;CANTOR COLBURN LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/674,131

(22) Filed: Sep. 29, 2003

(51) Int. Cl. G10L 11/00

(52) U.S. Cl. 704/272

(57) ABSTRACT

An apparatus for imaging the mouth of a user while detecting the speech of the user. The apparatus includes a headset. A video camera mounted to the headset is positioned so as to capture a frontal view of the mouth of a user. A microphone mounted to the headset is positioned so as to detect the speech of the user. An illumination source illuminates the mouth of the user. A communication device transmits the output of the video camera and the output of the microphone to a computer.

### BACKGROUND

Robust methods of voice recognition for voice to text applications, among others, has been a goal of researchers and product developers in the information processing industry for some time. One application of voice recognition technology exists, for example, in the securities industry. The typical securities industry environment is characterized by a trading floor where individuals are in constant communication with each other and with other parties by face to face or telephone methods. In the process, important records of trades and other functions are created, typically by manual methods. To adapt voice recognition technology to perform useful speech to record functions in this noisy environment is challenging. Researchers have established that audio data representing speech may be combined with video data representing mouth movement during speech to achieve a significantly reduced speech recognition error rate. There is a need for an apparatus for collecting speech data and video image data for processing by an audio/visual speech recognition system.

### SUMMARY OF THE INVENTION

An embodiment of the invention is an apparatus for imaging the mouth of a user while detecting the speech of the user. The apparatus includes a headset. A video camera mounted to the headset is positioned so as to capture a frontal view of the mouth of a user. A microphone mounted to the headset is positioned so as to detect the speech of the user. An illumination source illuminates the mouth of the user. A communication device transmits the output of the video camera and the output of the microphone to a computer.

### BRIEF DESCRIPTION OF THE DRAWINGS

FIG. 1 depicts a side view of a user wearing a headset in an embodiment of the invention.

FIG. 2 depicts a top view of a user wearing a headset in an embodiment of the invention.

FIG. 3 depicts a side view of a user wearing a headset in an alternate embodiment of the invention.

FIG. 4 depicts a top view of a user wearing a headset in an alternate embodiment of the invention.

FIG. 5 depicts a side view of a user wearing a headset in another embodiment of the invention.

FIG. 6 depicts a top view of a user wearing a headset in another embodiment of the invention.

FIG. 7 is a block diagram of headset circuitry in an embodiment of the invention.

### DETAILED DESCRIPTION

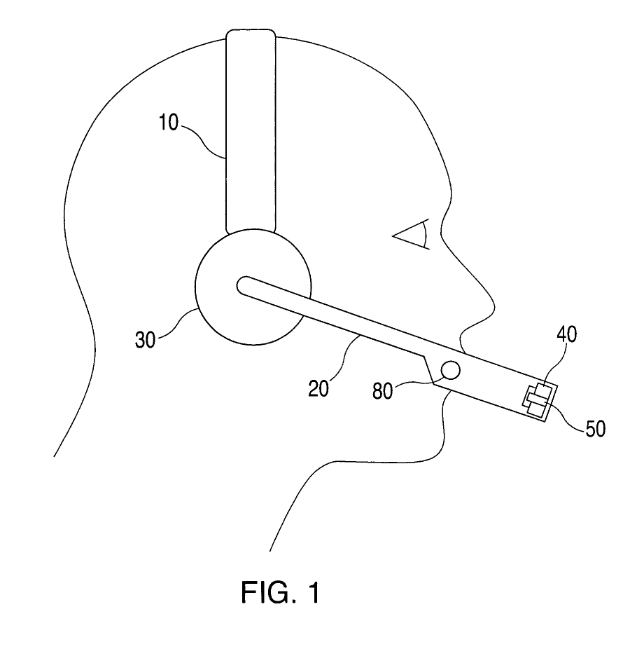

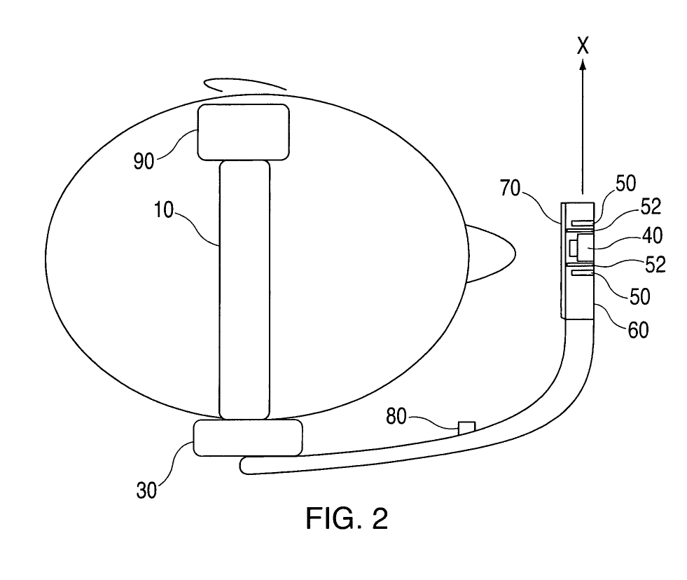

A headset in an exemplary embodiment of the invention is shown in FIG. 1 and FIG. 2. The headset includes a headband 10 that fits over the head of a user and further includes pads which contact the head at two or more points including the vicinity of the ears or on one or both ears. Connected to and supported by the headband and extending to the vicinity of the mouth is an extension or boom 20. The boom 20 and headband 10 are connected at a padded compartment 30 resting over the ear of the user wherein the compartment 30 contains circuitry associated with a camera, microphone and illumination source described in further detail herein.

The boom 20 is connected to the padded compartment 30 so as to permit the boom 20 to be positioned relative to the mouth over a limited range and then mechanically lock into place during a user setup procedure. The boom 20 is curved or angled such that the end of the boom 20 is located in front of the mouth of the user and incorporates a miniature video camera 40, for generating an image of the mouth, arranged so as to view the mouth of the user.

In one embodiment, the video camera 40 is a black and white CMOS type, for example a C-CAM2, but may also be a CCD type. The video camera 40 may be color or black and white, although black and white cameras are typically more adaptable for use with infrared illumination. Conventional supporting circuitry such as a voltage regulator for providing power to the video camera 40 may also be incorporated with the video camera 40.

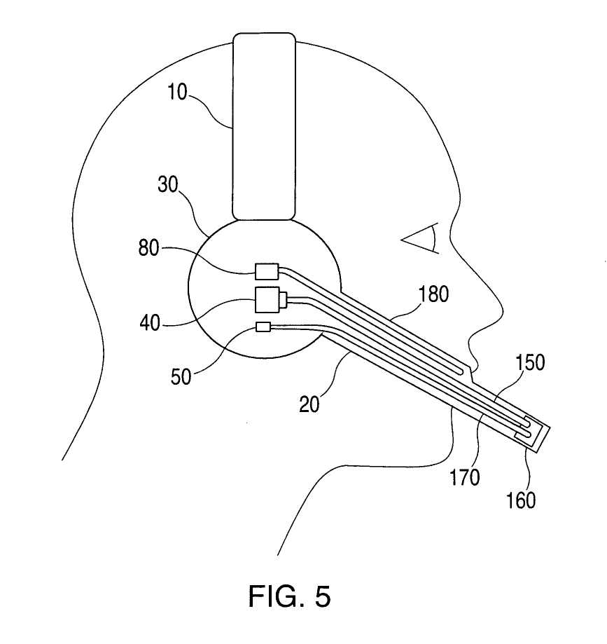

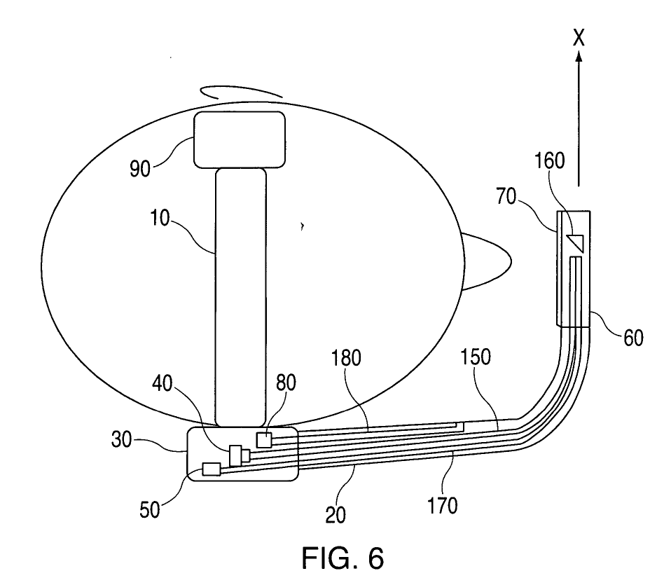

In an alternate embodiment shown in FIG. 5 and FIG. 6, the camera 40 is mounted in proximity to the headband 10, for example in compartment 30, and is optically coupled to a light guide such as a image transmitting coherent fiber optic cable 150. The fiber optic cable 150 is mounted in and extends through the boom 20 and opaque housing 60 in combination with a suitable lens, if any, mirror 160 and optical filter window 70 so as to view the mouth of the user and optically transmit the image of the mouth to the camera 40. The mirror 160 is adapted to the housing 60 so as to rotate with the housing 60, on the axis of the coherent fiber optic cable (shown as axis x), when the housing is rotated during the user setup procedure, while the fiber optic cables remain stationary. The image transmitted to the camera 40 will rotate as the mirror 160 rotates, which may require the speech recognition method to incorporate a correction which detects and accommodates for the rotation of the image.

Referring to FIGS. 1 and 2, one or more illumination sources 50 are placed adjacent to video camera 40 and oriented so as to illuminate the mouth. The illumination sources 50 may be used to supplement the existing ambient lighting which illuminates the face of the user. In an embodiment, the illumination sources 50 are infrared emitters which, in combination with an optical filter 70 adapted to the video camera 40, permits only infrared light to enter the video camera 40. This minimizes the effect of variations in ambient illumination on the viewed video image.

The optical filter 70 may be positioned only in front of the video camera 40 lens. In this embodiment, infrared LEDs 50 are exposed through openings in the opaque housing 60. In this embodiment, less power is needed to drive the LEDs 50 since there would not be the reduction of intensity that occurs when the LEDs are covered by the optical filter 70. This also extends battery life. The video camera 40 and LEDs 50 may still be covered by a transparent window, possibly painted on the inner surface except where light has to pass through, for cosmetic purposes.

Baffles or separators 52 may be positioned between the illumination sources 50 and the video camera 40. Depending on the physical size and arrangement of the video camera 40 and illumination sources 50, it may be desirable to have these baffles 52 in place for the purpose of reducing the effect of scattered or reflected infrared light from the inside surface of the optical filter 70 covering the video camera 40 and illumination sources 50. This scattered or reflected light could enter the video camera 40 and create bright spots or loss of contrast. The height of the baffles 52 is established so as to not block useful illumination of the mouth of the user, while reducing reflections.

The infrared emitters 50 may be of the light emitting diode type having a dominant emission wavelength in the infrared region or may be a broadband emitter. The optical filter 70 adapted to the video camera 40 may be designed so as to have a narrow pass band corresponding to a desired wavelength, or may be designed to block wavelengths in the visible range and pass a wide band of infrared wavelengths. Further, the optical filter 70 may be adapted to the illumination sources 50 as well as the video camera 40 so as to block the video camera 40 and illumination sources 50 from the view of the user while limiting the illumination to the infrared region. The illumination sources 50 may be constantly energized or intermittently energized.

In one embodiment, light emitting diodes (LEDs) are used as infrared sources since sufficient infrared emission may be obtained without the heat associated with incandescent sources. Infrared LEDs may be operated intermittently or periodically and in a constant current manner since the intensity falls off with time when LEDs are constantly energized. Alternatively, adjustable intermittent operation of the LEDs permits the illumination of the mouth to be optimized to obtain the best image of the mouth by adjustment of the average intensity. The adjustment of average intensity may be made infrequently or may be adapted to a sensor and related circuitry which monitors the illumination of the mouth and continuously adjusts the illumination to match a desired level. Further, the adjustable intermittent operation of the LEDs may be synchronized to the retrace or blanking times of the camera such that illumination is present only when the camera is actively collecting light.

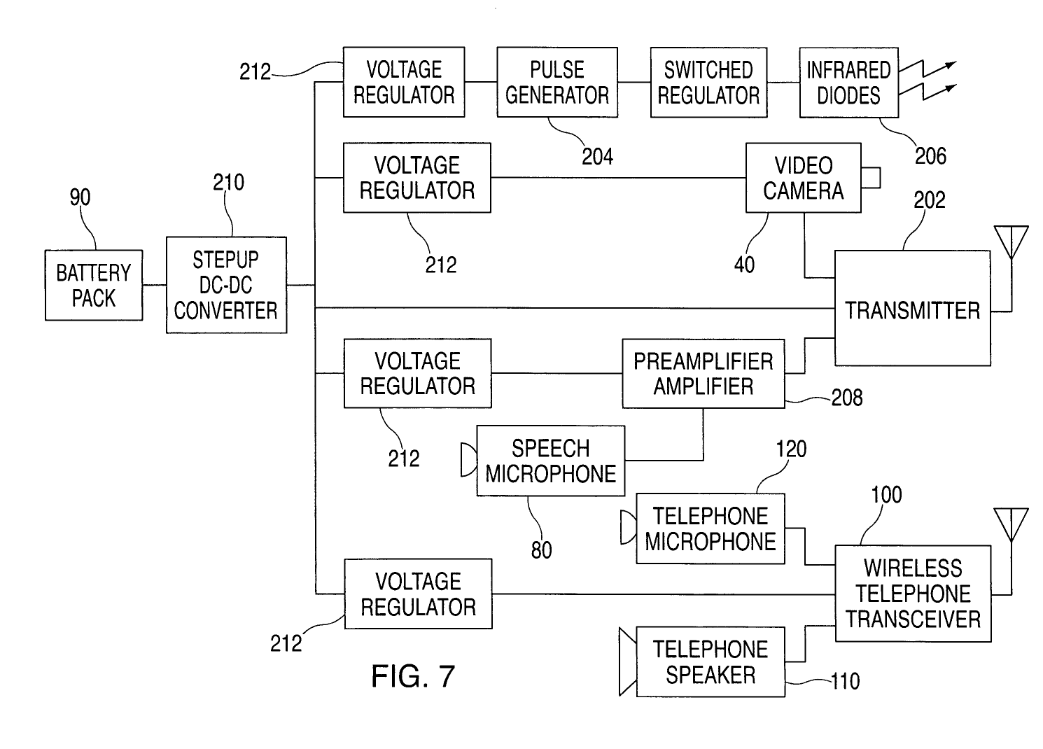

In the embodiment shown in FIG. 1 and FIG. 2, two infrared LEDs 50, for example a Fairchild F5E1, one on each side of the camera 40, are periodically energized by a pulse generator 204 (FIG. 7) having an adjustable pulse rate and independently adjustable pulse width and having an output adapted to provide the necessary current required by the LEDs. The camera 40 and LEDs 50 are enclosed in an opaque housing 60 having a window 70 made of an optical filter material which blocks visible light and passes a wide band of infrared wavelengths.

The housing 60 and boom 20 are adapted so as to permit the housing 60 to rotate relative to the boom over a limited range on an axis parallel to the mouth (shown as axis x in FIG. 2) during the user setup procedure.

Further, the housing 60 and window 70 serve to shape the distribution of the infrared illumination so as to minimize the exposure of the eyes of the user to the illumination as well as protect enclosed optical components from dust, moisture and debris. Further, the window may have variations in density and shape which modify the pattern of illumination to provide an optimal condition for image capture. In an alternate embodiment shown in FIG. 5 and FIG. 6, one or more illumination sources 50 and associated circuitry are mounted in proximity to the headband 10, for example in compartment 30, and are optically coupled to one or more light guides, such as incoherent fiber optic cables 170. The fiber optic cables 170 are mounted in and extend through the boom 20 and opaque housing 60 in combination with one or more suitable lenses, if any, mirror 160 and optical filter window 70 so as to illuminate the mouth of the user.

Referring to FIG. 1 and FIG. 2, a microphone 80 for detection of speech is mounted on the boom 20 in the vicinity of the mouth and in a position where the microphone 80 is unaffected by the user's breath. In one embodiment, the microphone 80 is an electret type having noise reduction properties. Conventional supporting circuitry such as a preamplifier, amplifier and voltage regulator may also be incorporated with the microphone. In the embodiment in FIG. 1 and FIG. 2, supporting circuitry including a preamplifier, for example an Analog Devices SSM2165-1, and an amplifier, for example a National Semiconductor LMV821M5, are incorporated in a compartment 30 located at the ear of the user.

In an alternate embodiment as in FIG. 5 and FIG. 6, the microphone 80 is mounted in proximity to the headband 10, for example in compartment 30, and acoustically coupled to a tube 180 mounted in and extending through the boom 20 to a position in the vicinity of the mouth so as to detect the speech of the user.

In the embodiment of FIG. 1 and FIG. 2, the camera 40 and illumination sources 50 are positioned directly in front of the mouth substantially on the center line of the mouth. The optical properties of the camera 40 are adapted to a suitable viewing distance, nominally 50 mm in front of the mouth. The camera 40 and illumination sources 50 may also be positioned to the side of the center line of the mouth to the extent that the shape of the mouth can still be sufficiently reconstructed by a suitable analysis method.

In an alternate embodiment shown in FIG. 5 and FIG. 6, the camera 40 and/or illumination sources 50 are mounted in proximity to the headband and are optically coupled to fiber optic cables which, in combination with lenses and mirrors, view and or illuminate the mouth of the user. The lenses and mirrors may also be positioned to the side of the center line of the mouth to the extent that the shape of the mouth can still be sufficiently reconstructed by a suitable analysis method.

The boom 20 may be adapted to be able to be positioned on either side of the user, especially if the view of the mouth and illumination of the mouth is not substantially on the center line of the mouth. This would permit accommodating the preference of a user but, more importantly, may also permit more robust recognition of the speech of a user who, habitually or because of physiological or medical reasons, speaks primarily through one side of the mouth.

The video signals from the camera 40 and the audio signals from the microphone 80 are communicated to a computer incorporating a suitable method of speech recognition using speech data in combination with video data. The signals may be digitized to create data corresponding to the signals either within the headset or within the computer. The microphone 80 and the camera 40 may be directly connected (e.g., through cabling such as wires, optical fiber, etc.) to a computer adapted to receive the data and further adapted to provide power to the camera and microphone.

In an another embodiment, the communication device incorporates a miniature radio frequency transmitter 202 (FIG. 7) and corresponding receiver operating at a frequency, for example, of 1.2 GHz. FIG. 7 is a block diagram of circuitry in an embodiment of the headset. The transmitter 202 is adapted to the headset, for example incorporated in compartment 30, and the receiver is adapted to the computer so as to implement one-way wireless communication of video and speech signals from the headset to the computer. Further, a pulse generator 204 for the infrared LEDs 206 is incorporated in the boom 20, for example in opaque housing 60. An amplifier 208 for the microphone 80 is incorporated in the headset, for example in compartment 30. Further, a battery pack 90 mounted on a pad above the ear of the user is adapted to the headset so as to provide appropriate voltages and currents to the various circuitry. A DC-DC converter 210 provides power to the components through one or more voltage regulators 212.

This apparatus permits the user to move about while utilizing the features of the invention without being restricted by a wired connection. In another embodiment, the microphone 80 and the video camera 40 may each be embedded in separate transmitters, for example utilizing Bluetooth technology, and transmit on separate channels. This may serve to reduce the total circuitry and associated size and power requirements.

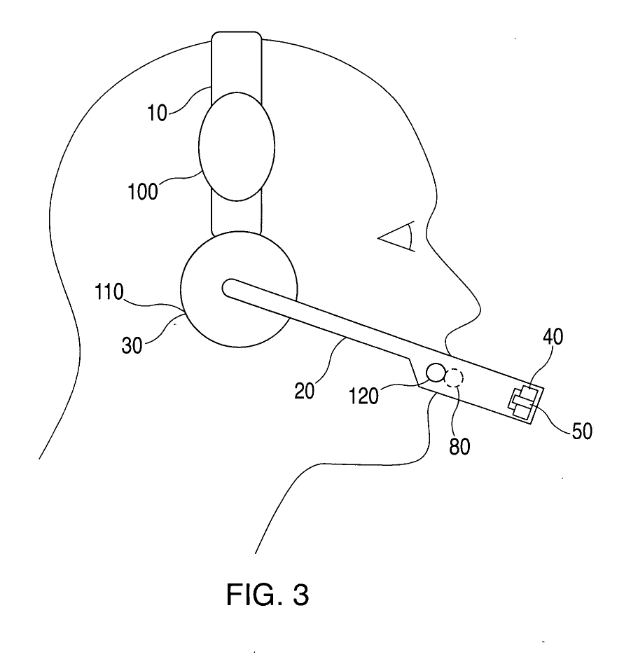

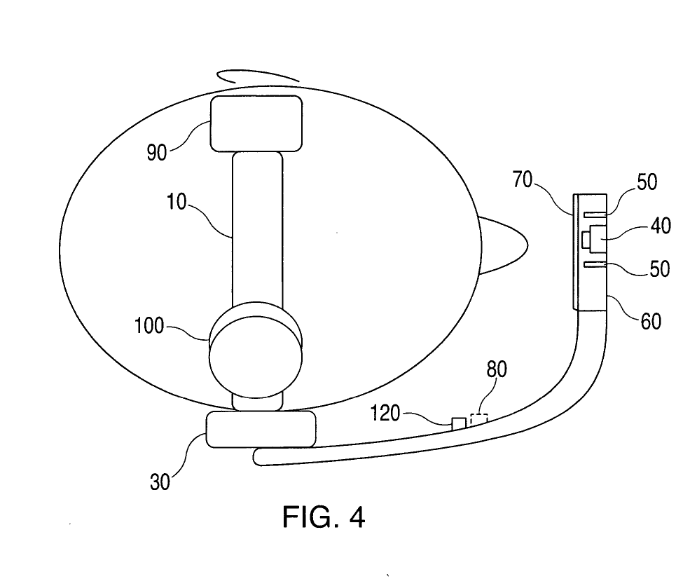

An alternate embodiment shown in FIG. 3 and FIG. 4 incorporates a separate wireless telephone transceiver 100 into the headset for the convenience of the user. This wireless telephone transceiver 100 is adapted to the headset along with telephone audio speaker 110 in a compartment 30 at the ear of the user and a telephone microphone 120 on boom 20 in the vicinity of the mouth of the user. Speaker 110 and microphone 120 are connected to wireless telephone transceiver 100 to provide wireless telephone functions.

The one-way communication of video and speech data to the speech recognition computer may be implemented using two-way communication by the use of suitable transmitter/receiver at the headset and at the computer. This may include using, for example, conventional technologies such as Bluetooth or WiFi (IEEE 802.11b). The headset may be adapted to connect the headset transmitter/receiver to an audio speaker at the ear of the user and a microphone at the mouth of the user. Telephone functionality may be implemented by establishing telephone communication through the computer (e.g., voice over IP). The user may alternate between speech recognition functionality and telephony as desired. Switching between speech recognition and telephony may be performed, for example, mechanically with a switch at the headset. Alternatively, a keyboard command at the computer or using speech recognition within the computer may be used to toggle between speech recognition and telephony.

If two-way communication is implemented, the user will have the benefit of a headset setup and alignment procedure wherein a method of audio and or visual feedback may assist the user in optimally positioning the view of the camera. This method may include analysis of the transmitted image of the mouth by a suitable computer means combined with audio and or visual signals communicated to the user as the headset and boom positions are manipulated. The audio signals may be tones or synthesized voice instruction communicated to the audio speaker in the headset. Alternatively or in combination with audio signals, visual signals may include, for example, selective illumination of an array of LEDs incorporated in the boom for the purpose of alignment. Preferably, the visual signal would appear on a display adapted to the computer and would be, for example, related to the immediate position of the mouth or lip region relative to alignment indicators on the display.

While preferred embodiments have been shown and described, various modifications and substitutions may be made thereto without departing from the spirit and scope of the invention. Accordingly, it is to be understood that the present invention has been described by way of illustration and not limitation.

1. An apparatus for imaging the mouth of a user while detecting the speech of the user comprising:
a headset adapted so as to be worn on the head of the user;
a video camera mounted on the headset and positioned so as to capture a frontal view of the mouth of a user;
a microphone mounted on the headset and positioned so as to detect the speech of the user;
an illumination source mounted on the headset for illuminating the mouth of the user;
a communication device transmitting the output of the video camera and the output of the microphone to a computer.

2. The apparatus of claim 1 wherein the video camera is a black and white CMOS type camera.

3. The apparatus of claim 1 wherein the video camera is a color CMOS type camera.

4. The apparatus of claim 1 wherein the video camera is a black and white CCD type camera.

5. The apparatus of claim 1 wherein the video camera is a color CCD type camera.

6. The apparatus of claim 1 wherein the video camera is positioned so as to capture a frontal view of the mouth of the user and is positioned substantially on the center line of the mouth.

7. The apparatus of claim 1 wherein the video camera positioned so as to capture a frontal view of the mouth of the user and is positioned to the side of the center line of the mouth.

8. The apparatus of claim 1 further comprising an optical filter limiting light entering the video camera to a band of infrared wavelengths.

9. The apparatus of claim 1 wherein the microphone is of the noise reduction type.

10. The apparatus of claim 1 wherein the illumination source includes a plurality of broadband light emitters.

11. The apparatus of claim 10 further comprising an optical filter limiting light emitted from said broadband light emitters to a band of infrared wavelengths.

12. The apparatus of claim 1 wherein the illumination source includes a plurality of narrowband light emitters.

13. The apparatus of claim 12 further comprising an optical filter limiting light emitted from said narrowband light emitters to a band of infrared wavelengths.

14. The apparatus of claim 1 wherein the illumination source is continuously energized.

15. The apparatus of claim 1 wherein the illumination source is periodically energized.

16. The apparatus of claim 15 wherein the illumination source is de-energized during retrace or blanking periods of the video camera.

17. The apparatus of claim 15 wherein the illumination source is periodically energized by a pulse generator having a pulsed output, wherein a period of the pulsed output and a pulse width of the pulsed output are independently controlled.

18. The apparatus of claim 1 wherein the headset includes a boom supporting the video camera and illumination source so as to capture the frontal view of the mouth.

19. The apparatus of claim 18 wherein the boom supports the microphone to position the microphone in the vicinity of the mouth.

20. The apparatus of claim 1 further comprising an amplifier coupled to the microphone.

21. The apparatus of claim 1 wherein the communication device includes a radio frequency transmitter receiving the video output of the video camera and the audio output of the microphone and a corresponding receiver adapted to provide the video and audio to the computer.

22. The apparatus of claim 1 wherein the communication device is cabling.

23. The apparatus of claim 1 further comprising a speaker for transmitting sound to the user, the speaker positioned in proximity to the ear of the user.

24. The apparatus of claim 23 further comprising a communication path from the computer to the speaker.

25. The apparatus of claim 24 wherein the communication device for communicating the output of the microphone to the computer and communication path from the computer to the speaker are used in combination to perform conventional telephony wherein the computer communicates with conventional telephony interfaces.

26. The apparatus of claim 25 wherein the computer is adapted to perform telephony functions over the internet.

27. The apparatus of claim 1 further comprising:
a speaker for transmitting sound to the user, the speaker positioned in proximity to the ear of the user;
a wireless telephony transceiver connected to the speaker and the microphone to provide wireless telephony functions.

28. The apparatus of claim 1 wherein the illumination source is adjustable to shape a light output distribution to reduce exposure of eyes of the user to the light output.

29. The apparatus of claim 1 further comprising a fiber optic cable providing an optical image of the frontal view of the mouth to the video camera.

30. The apparatus of claim 1 wherein the illumination source includes a fiber optic cable to illuminate the mouth of the user.

31. The apparatus of claim 1 further comprising a tube acoustically coupled to the microphone so as to provide speech of the user to the microphone.
